(19) United States
(12) Patent Application Publication
(10) Pub. No.: US 2012/0080895 A1
(43) Pub. Date: Apr. 5, 2012

(54) LIFTING HOOK DEVICE

(76) Inventor: Mitsuo Aoki, Shizuoka (JP)

(21) Appl. No.: 13/377,685

(22) PCT Filed: Jun. 22, 2009
(86) PCT No.: PCT/JP09/61311

§ 371 Date: Dec. 12, 2011

(51) Int. Cl. B66C 1/34

(52) U.S. Cl. 294/82.15

(57) ABSTRACT

A lifting hook device which can, irrespective of the height of lifting, stably and quickly lift up a load with the load constantly oriented to a certain direction. A lifting hook device comprises a fixed hook (3) for lifting provided to a head section (2a) of a hollow body (2) having an inside maintained airtight, a rotatable hook (5) for suspending a load, the rotatable hook (5) having a shaft section (5a) rotatably supported supported in the body and vertically suspended from a bottom section (2c), a motor (8) for rotating the shaft section (5a) of the rotatable book about the axis of the shaft section through a rotating mechanism (7), an azimuth sensor (10) mounted to the rotatable hook and detecting the rotational azimuth of the rotatable hook, and a control section (11) for controlling rotation of the motor to restrict the orientation of the rotatable hook to a predetermined direction.

### TECHNICAL FIELD

The present invention relates to a lifting hook device for lifting up a load by suspending on a wire-rope vertically suspended from a winch, such as a crane etc., and furthermore relates to a lifting hook device in such a way to lift up with constantly keeping a certain direction by avoiding the rotation of the load in case of especially lifting up the load from an altitude.

### BACKGROUND ART

In general, a lifting hook device is used for a mounting and a cargo handling in a construction field and a harbor etc.. In such a case, the device is lifting up the load by hanging a wire-rope on a load and hanging a suspending hook vertically suspended from a winch, such as a crane etc., on the wire-rope. However, in case of lifting up the load, the load rotates on the suspending hook by the effect of oscillation and wind etc., and it is danger of hitting surrounding objects and workers. So, previously, the various methods and devices have been suggested in order to stop the rotation of the load.

For example, a machinery for stopping the rotation of the crane hook in such a way to mechanically-regulate the rotation of a suspending hook is described in Patent Document 1, so that the suspending hook vertically suspended from the housing, i.e., the body freely rotates in case of no-load, and thereby a protrusion mounted in the body is fitted on a hollow by applying the load.

Moreover, a lifting device in such a way to return the lifting device to the prescribed direction, by driving the machine for promoting a circling by a processing signal to estimate and process that the lifting device circles in any directions by a magnetic azimuth sensor mounted on the lifting device suspended by crane, is described in Patent Document 2.

### The List of Prior Art Document

### Patent Document

Patent Document 1: Japanese Patent Application Laid-Open No. H07-228468 A

Patent Document 2: Japanese Patent Application Laid-Open No. H05-24783 A

### SUMMARY OF THE INVENTION

### Problems to be Solved by the Invention

However, the range of the applications is incapacious, because the any of the above lifting hook devices are used for the machine for flatly carrying the load lifted by crane, i.e., motivity, therefore, said lifting hook devices are restricted in the work in case of that the height of the lifting is comparatively lower.

In particular, in the hook device described in Patent Document 1, even if the rotation of the suspending hook suspended the load is regulated, in case that (two) lengths of wire-ropes for lifting, vertically suspended from crane and suspended the main body, are long, to safely lifting the load is difficult by that the wire-ropes still swing and rotate under vibrancy and wind etc..

Moreover, the lifting device, i.e., the hook device described in Patent Document 2 is provided with a rotational and universal hook suspended a hook vertically suspended from crane in a head of a body and has a fixed hook for lifting up the load, which is integrally suspended with the body in a bottom of the body, to the head of the body, whereas the construction of the device described in Patent Document 2 is different from a lifting hook device of the present invention having a rotational hook for suspending a load to a bottom of a body. Furthermore, the hook device described in Patent Document 2, whose frame, i.e., body is cuboidally formed, has no provision for problems of air resistance and a rotation of the body in case lifting up the hook device to a particularly altitude and rain water etc..

In case of lifting up the load to a particularly altitude, for example, in case accidents, such as water accident in sea and river etc., fire accident in a high-rise building, or distress in mountain by climbing and skiing etc., go on, a helicopter goes into these action, twisting the long wire-rope vertically suspending from midair (of the helicopter) around the distress person(s), and the distress person(s) is/are saved by lifting up with a rescue worker by a winch mounted on the helicopter, however, in this way, in case of lifting up the distress person(s) by vertically suspending the long wire-rope from the altitude, the lift-up working in a time-sensitive situation is more difficult because the loads, i.e., the rescue worker and the distress person(s) swing and rotate in a horizontal direction thereby strongly receiving air and whether, in particular, in the process of lifting up.

It is an object of the present invention to improve the prior art, and the purpose of the present invention is to provide a lifting hook device which can, irrespective of the height of lifting, stably and quickly lift up a load with the load constantly oriented to a certain direction.

### Means for Solving the Problems

In order to accomplish the present invention, a lifting hook device, having a fixed hook for lifting on a head section of a body and a rotatable hook for suspending a load on a bottom section of said body, which is fixed and mounted said fixed hook in said head section of said body having an inside maintained airtight, whereas a shaft section is rotatably supported said rotatable hook inside said body, and a hook section is mounted in such a way to vertically suspend from said bottom section of said body, wherein said body comprises a rotation mechanism for rotating a shaft section of said rotatable hook around a shaft line, a motor for rotating said shaft section in both of normal and reverse directions by driving said rotation mechanism, a battery cell which is a electrical power of said motor, an azimuth sensor for detecting a rotational direction of said rotatable hook mounted in said rotatable hook, and a control section for controlling a direction of said rotatable hook by controlling a rotation of said motor based on a directional signal detected by said azimuth sensor.

In order to accomplish the present invention, said azimuth sensor is a magnetic azimuth sensor (a GPS sensor), and a GPS antenna for detecting an electrical wave from GPS satellites is provided in said body.

In order to accomplish the present invention, said motor is remote-controlled by a switch at hand.

In order to accomplish the present invention, said azimuth sensor is provided in a top end of said shaft section of said rotatable hook.

In order to accomplish the present invention, said body has said head section conically or a conical-trapezoidally formed, and wherein a sealing element is provided in a open section which said rotatable hook of said bottom section vertically suspends.

In order to accomplish the present invention, a battery cell for driving said motor is a charging type, and said battery cell is detachably provided in said body.

In order to accomplish the present invention, said rotation mechanism comprises of a worm connected to a driving shaft of said motor and a worm wheel, placed in the shaft section of said rotatable hook, engaging to said worm.

### Advantageous Effects of the Invention

That is, according to the lifting hook device of the present invention, the lifting hook device can, irrespective of the height of lifting, stably and quickly lift up the load suspended on the rotatable hook for suspending constantly oriented to a certain direction by employing the construction of the claim 1 of the present invention.

In particular, according to the lifting hook device consisted in such a way as to have a GPS sensor and receive the direction on contact with a GPS antenna, it is operable to detect the certain orientation, moreover, to turn the azimuth sensor on or off by a remote-control operation, and it is easily operable by hand work in case of suspending the load on the suspending hook. Moreover, it is operable to reduce the air resistance in the lifting because the head of the body of the device is formed in conically shaped or circular truncated cone, furthermore, the device of the present invention has a advantage that it is operable to work of lifting in rainfall time or from water because the body has a waterproof structure etc..

### BRIEF DESCRIPTION OF THE DRAWINGS

FIG. 1 is a front sectional view showing the lifting hook device in one embodiment of the present invention.

FIG. 2 is a right lateral (part of sectional) view of FIG. 1.

FIG. 3 is a plane view of FIG. 1.

FIG. 4 is a block diagram showing a control system in the embodiment.

### MODE FOR CARRYING OUT THE INVENTION

Hereinafter, the invention will now be explained in more detail with reference to figures illustrated in a drawing. As well, it goes without saying that, the present invention is not always limited to the follow embodiment, but is possible to variously change the construction without departing from the claims of the present invention.

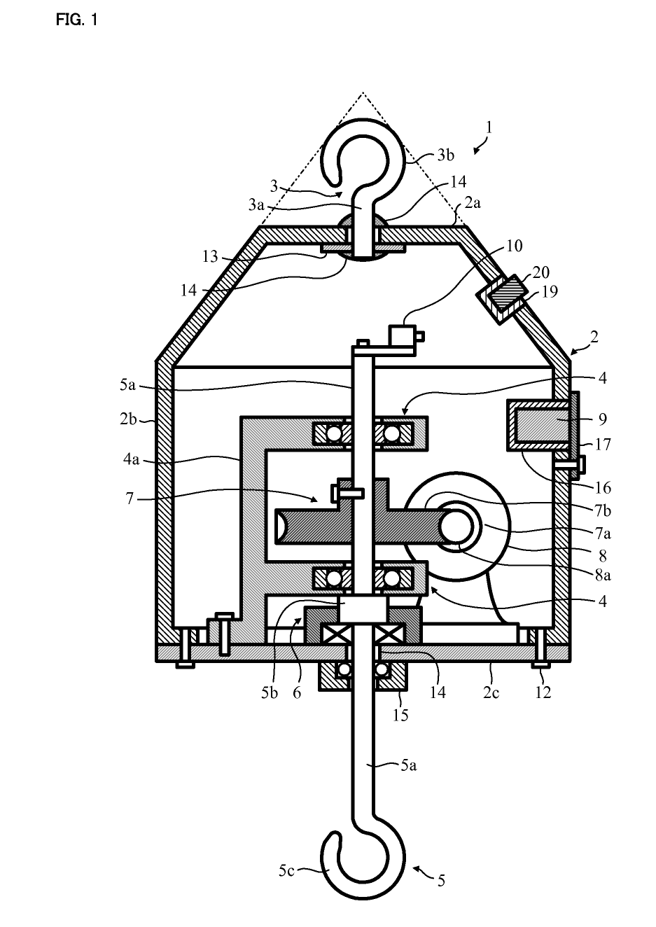

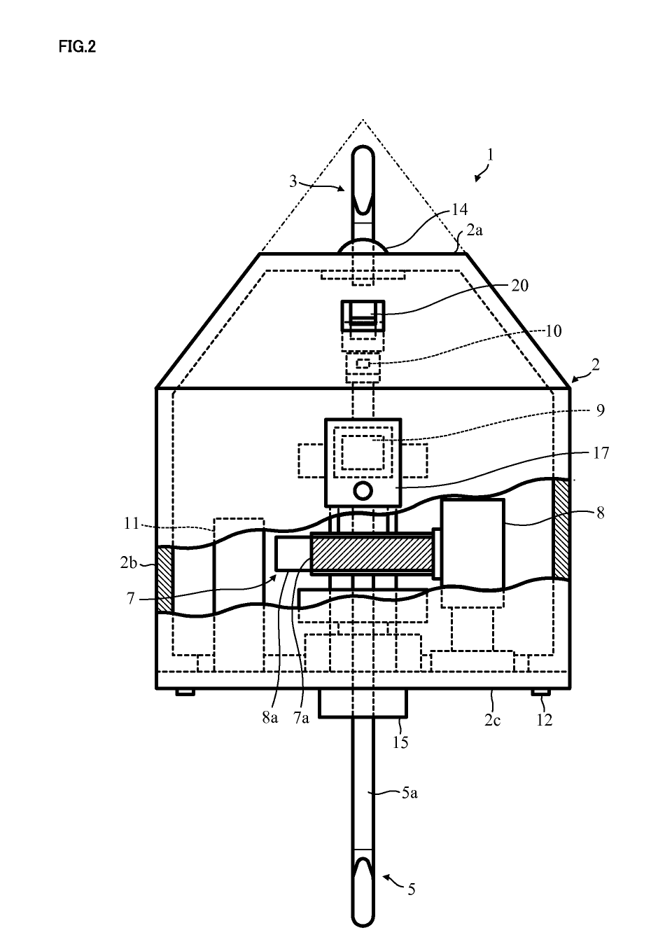

FIG. 1 is a front sectional view showing the lifting hook device in one embodiment of the present invention, FIG. 2 is a right lateral (a part of sectional) view of FIG. 1, and FIG. 3 is a plane view of FIG. 1.

A lifting hook device 1 mainly comprises a hollow body 2 having an inside maintained airtight, a fixed hook 3 for lifting up having an shaft section 3a fixed to a head section 2a of the body 2 and a hook section 3b provided by projecting upward, a rotatable hook 5 for suspending having a shaft section 5a that is rotatably connected to a shaft ball bearing 4 attached to a bracket 4a in a body section 2b of the body 2, a stepped section 5b that is rotatably connected to a shaft thrust bearing 6 inside a bottom section 2c of the body 2, and a hook section 5c provided by vertically suspending from the bottom section 2c, a rotating mechanism 7 rotating the rotatable hook 5 around shaft line, a forward-reverse rotatable motor 8 driving the rotating mechanism 7, a battery cell 9 for supplying electric power provided in the body section 2b of the body 2, a magnetic azimuth sensor (GPS sensor) 10 for detecting a rotational direction of the rotatable hook 5 attached to a top section of the shaft section 5a of the rotatable hook 5, and a control section 11 for controlling the rotation of the motor 8 based on a sensing signal of the magnetic azimuth sensor 10 and controlling a direction of the rotatable hook 5 to a predetermined direction.

The body 2 comprises of the head section 2a conical-trapezoidally formed, the body section 2b cylindrically juncturally formed in the head section 2a, and the bottom section 2c fixed a circular bottom plate by a screw/screws in an open lower surface of the body section 2b. In this way, in case of conical-trapezoidally forming the head section 2a, it is operable to firm the load by controlling a horizontal swing of the lifting hook device 1 thereby being operable to reduce the air resistance, which the body 2 is served, when the lifting hook device 1 is lifted up (that is, transferring upward). Moreover, by cylindrically forming the body section 2b, it is operable to quickly lift up the load thereby being operable to firm the body for the rotation.

As shown in FIG. 1, a reinforcing plate 13 is provided inside of the head section 2a, the shaft section 3a of the fixed hook 3 is inserted into the reinforcing plate 13, and the fixed hook 3 is fixed in and out of the head section 2a by a weld 14. On the hook section 3b of the fixed hook 3, a wire-rope for lifting up (not shown) vertically suspended from upward is suspended.

The rotatable hook 5 is provided in such a way that the bottom shaft section 5a is inserted into an open section 14 formed in a center section of the bottom section 2c of the body 2 and the hook section 5c is vertically suspended. As well, an O-ring 15 is provided in the open section 14 from the outside of the bottom section 2c, a friud prevents in the inside of the body 2 from entering, and the inside of the body 2 keeps being mainteind airtight.

The rotating mechanism 7 comprises a worm 7a integrally mounted in a driving shaft 8a of the motor 8 and a worm wheel 7b engaging the worm 7a. The worm wheel 7b is fitted and fixed in the shaft section 5a of the rotatable hook 5, and the shaft section 5a is rotating around a shaft line by the driving of the motor 8. It is operable to produce a compact and an inexpensive device, because the rotating mechanism 7 is, that the construction of the mechanism 7 is simple, and does not also need a large installation space.

As presented above, the motor 8 is rotatable in both of forward and backward directions, and an electric power is provided from the battery cell 9. The battery cell 9, which is a charging type, is easily put in a mounting section 16 provided a recess in the body section 2b of the body 2 and is closed by a cap 17. As well, The motor 8 and the battery cell 9 are commercially-supplied and heretofore known articles, and these types, performances, and capacities etc. are selected from the adequate article based on the weight and the lifting speed of the load vertically suspended to the rotatable hook 5.

A mounting section 19 is provided a recess in a position near the magnetic azimuth sensor 10 in the head section 2a of the body 2, and a general GPS antenna 20 for receiving an electrical wave from GPS satellite is mounted in the mounting section 19. In this way, by mounting the GPS antenna 20 in the body 2, it is operable to receive a strong electrical wave, and it is operable to detect a certain direction.

In the embodiment, the general magnetic azimuth sensor 10, which has a comparatively easily installation, is preferably used as an azimuth sensor for detecting a rotational direction of the rotatable (for suspending) hook 5.

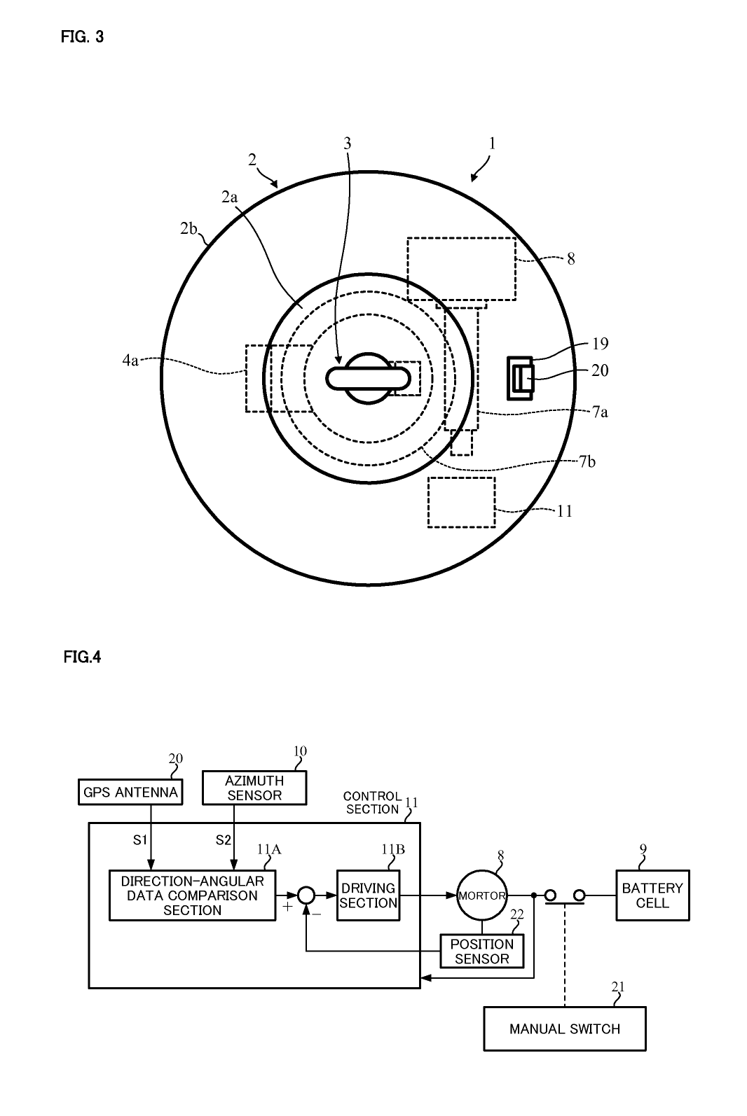

As shown in a block diagram of FIG. 4, the control section 11 comprises a comparison section of direction angular data 11A and a driving section 11B.

In the comparison section of direction angular data 11A, a directional information signal S1 from the GPS antenna 20 and a directional information signal S2 from the magnetic azimuth sensor 10 are input while this reference, i.e., an amount of a declination to a predetermined direction of the rotatable hook 5 is calculated, and the information is input in the driving section 11B. A rotation-positional information of the motor 8 is input in the driving section 11B through a position sensor 22, while the extent to rotate the rotatable hook 5 in any directions of right or left to the predetermined direction based on these information is estimated. This handling signal is input in the motor 8, the rotation mechanism 7 is driven whereby the motor 8 rotates in normal or in reverse corresponding to this figure, and the rotatable hook 5 is controlled in such a way to be located in the predetermined direction.

In the embodiment, as shown by the diagram, a switch at hand 21 is mounted between the motor 8 and the battery cell 9, and the electric power of the motor 8 is turned off in case of freely rotating the rotatable hook 5, for example, in case of suspending or unloading the load to the rotatable hook 5 etc..

The lifting hook device 1 is constructed as above, therefore, has a distinguished effect as described in the above column of “ADVANTAGEOUS EFFECTS OF THE INVENTION”.

Thus, we have explained the content of the present invention based on one embodiment, but the present invention is not restricted to such embodiment as described the above.

For example, it is possible to cone the form of the head section 2a of the body 2 as shown by virtual lines in FIGS. 1 and 2. In this way, by coning the form of the head section 2a, in common with the conical-trapezoidally form of said embodiment, it is operable to reduce the air resistance, which the body 2 is served, while it is operable to firm the load by controlling the swing of the horizontal direction of the lifting hook device 1.

In said embodiment provides the GPS antenna 20 in the body 2, but it is not always necessary depending on the environmental condition, such as the condition of the receiving of the electrical wave.

Moreover, in said embodiment uses the magnetic azimuth sensor as the azimuth sensor; in addition, it is possible to use a gyro-sensor or a gyro-ultrasonic sensor.

Furthermore, the lifting hook device of the present invention is not restricted to the work, such as the lifting of heavy loads by using the crane and the conveyance etc., but it is operable to optimally use in particular for the lifting work from altitude, such as the rescue work from the midair by helicopter etc..

### REFERENCE NUMERALS

1 lifting hook device

2 body

2a head section

2b body section

2c bottom section

3 fixed fook (for lifting)

3a shaft section

3b hook section

4 shaft ball bearing

5 rotatable hook (for suspending)

5a shaft section

5b stepped section

5c hook section

6 shaft thrust bearing

7 rotating mechanism

7a worm

7b worm wheel

8 motor

9 battery cell

10 magnetic azimuth sensor

11 control section

15 O-ring

20 GPS antenna

21 switch at hand

1-7. (canceled)

8. A lifting hook device, having a fixed hook for lifting on a head section of a body and a rotatable hook for suspending a load on a bottom section of said body, which is fixed and mounted said fixed hook in said head section of said body having an inside maintained airtight, whereas a shaft section is rotatably supported said rotatable hook inside said body, and a hook section is mounted in such a way to vertically suspend from said bottom section of said body, wherein;
said body comprises a rotation mechanism for rotating a shaft section of said rotatable hook around a shaft line, a motor for rotating said shaft section in both of normal and reverse directions by driving said rotation mechanism, a battery cell which is a electrical power of said motor, an azimuth sensor for detecting a rotational direction of said rotatable hook mounted in said rotatable hook, and a control section for controlling a direction of said rotatable hook by controlling a rotation of said motor based on a directional signal detected by said azimuth sensor,
said body has said head section conically or a conical-trapezoidally formed, and
a sealing element is provided in a open section which said rotatable hook of said bottom section vertically suspends.

9. The lifting hook device according to claim 8, wherein said azimuth sensor is a magnetic azimuth sensor (a GPS sensor), and wherein a GPS antenna for detecting an electrical wave from GPS satellites is provided in said body.

10. The lifting hook device according to claim 8, wherein said motor is remote-controlled by a switch at hand.

11. The lifting hook device according to claim 8, wherein said azimuth sensor is provided in a top end of said shaft section of said rotatable hook.

12. The lifting hook device according to claim 8, wherein a battery cell for driving said motor is a charging type, and wherein said battery cell is detachably provided in said body.

13. The lifting hook device according to claim 8, wherein said rotation mechanism comprises a worm connected to a driving shaft of said motor and a worm wheel, placed in the shaft section of said rotatable hook, engaging to said worm.
